(19) United States
(12) Patent Application Publication
(10) Pub. No.: US 2008/0191878 A1
(43) Pub. Date: Aug. 14, 2008

(54) Consumer-Centric Rfid Point of Sale Transaction System and Method

(75) Inventor: Gerald G. Abraham, Saratoga Springs, NY (US)

Correspondence Address: EATON PEABODY PATENT GROUP, LLC, P.O. BOX 5249, 77 Sewall Street, Suite 3000, AUGUSTA, ME, 04332-5249, US

(73) Assignee: GABA HOLDINGS INTERNATIONAL, INC., Toronto, ON (CA)

(21) Appl. No.: 11/915,583

(22) PCT Filed: Apr. 5, 2006
(86) PCT No.: PCT/CA2006/000516

§ 371 Date: Nov. 26, 2007

Related U.S. Application Data
(60) Provisional application No. 60/684,963, filed on May 27, 2005.

(51) Int. Cl. G08B 13/22

(52) U.S. Cl. 340/572.1

(57) ABSTRACT

A consumer-centric point of sale transaction system and method are provided. The system includes a wireless appliance, an authorization card or device with an embedded RFID Tag containing encrypted information, a hard copy product and a wireless telecommunications network based (MPOS) transaction system. The wireless appliance includes a radio frequency identification (RFID) reader/writer The hard copy product includes a product RFID tag. The authorization smart card also contains an RFID tag. The wireless telecommunications network based (MPOS) transaction system is to provide product information and purchase options to the wireless appliance based on the product RFID tag, and to perform point of sale transactions. The product information and purchase options can be provided from a content media portal, or a product repository. The system can additionally enable consumer-initiated purchase without a cashier, and can provide pre-purchase product information, either by consumer request or by providing general information of interest, such as items for sale or on special.

### CROSS REFERENCE TO RELATED APPLICATIONS

This application claims the benefit of priority of U.S. Provisional Patent Application No. 60/684,963 filed May 27, 2005, which is incorporated herein by reference.

### FIELD OF THE INVENTION

The present invention relates generally to point of sale transactions. More particularly, the present invention relates to point of sale transactions, and transaction-related functions generated by a wireless handheld device, using radio frequency identification (RFID).

### BACKGROUND OF THE INVENTION

Radio frequency identification (RFID) is a method of remotely storing and retrieving data using devices called RFID tags/transponders. An RFID tag is a small object, such as an adhesive sticker, that can be attached to or incorporated into a product. RFID tags include antennas to enable them to receive and respond to radio-frequency queries from an RFID transceiver, also referred to as an RFID transponder or reader.

RFID tags can be either active or passive. Passive RFID tags do not have their own power supply since the minute electrical current induced in the antenna by the incoming radio-frequency scan provides enough power for the tag to send a response. Lack of its own power supply makes the device quite small with some commercially available products measuring 0.4 mm×0.4 mm and thinner than a sheet of paper. These devices are practically invisible to the human eye. Passive tags have practical read ranges that vary from about 10 mm up to about 6 metres. Due to power and cost concerns, the response of a passive RFID tag is necessarily brief and is typically made up of a series of components originating from various devices internally or just an ID or string in the form of a GUID (Graphical User Identification) number, e.g. “9AC6885459DC45EA900035A7A320C4F8”, link to an associated archive originating from a distant repository.

There are four different kinds of tags commonly in use and are categorized by their radio frequency: Low frequency tags (between 125 to 136 kilohertz), High frequency tags (13.56 megahertz), UHF tags (868 to 956 megahertz), and Microwave tags (2.45 gigahertz). UHF tags cannot be used globally as there are no global regulations for their usage.

Active RFID tags, on the other hand, must have a power source, and may have longer ranges and larger memories than passive tags, as well as the ability to store additional information sent by the transceiver. At present, the smallest active tags are about the size of a small coin. Many active tags have practical ranges of tens of metres, and a battery life of up to several years. While the cost advantages of passive tags over active tags are significant, other factors including accuracy and reliability make the use of active RFID tags very common today.

An RFID system can include several components including tags, tag readers, tag programming stations, circulation readers, sorting equipment, and tag inventory wands. The purpose of an RFID system is to enable data to be transmitted by a portable device, or a tag, which is read by an RFID reader and processed according to the needs of a particular application. The data transmitted by the tag may provide identification or location information, or specifics about the product tagged, such as price, color, date of purchase, etc.

In a typical RFID system, individual objects are equipped with a small, inexpensive RFID tag. The tag comprises a transponder with a digital memory chip that is given a unique electronic product code. An interrogator, such as an antenna packaged with a transceiver and decoder, emits a signal activating the RFID tag so that data can be read from and written to it. When an RFID tag passes through an electromagnetic zone, the reader's activation signal is detected. The reader decodes the data encoded in the tag's integrated circuit (silicon chip) and the data passed to the host computer for processing.

Although some systems using RFID tags are used for inventory and pet identification purposes, the facilitation of point of sale (POS) transactions is also a common application. For instance, one such system provides consumers with an RFID tag on a key chain, to be read by an RFID reader at a fuel pump or at a cash register. The RFID tag stores and transmits an identification code, on the basis of which a credit card transaction can be processed via the vendor's own transaction processing system/network. However, such an RFID system provides only limited interaction and is focused on facilitating a particular aspect of a transaction, as part of a proprietary system. The RFID reader is controlled by the vendor and is part of the vendor's system.

Currently, with respect to point of sale transactions, there is a clear distinction between printed hard copy content and digital content. One of the few links between printed content and related digital content is a uniform resource locator (URL), or web site address, often placed in advertisements. A consumer must manually enter the URL into a browser on a device connected to the Internet in order to acquire more information about the printed content, or product or service described. Point of sale transactions for hard copy content are presently limited to a vendor being able to scan a bar code to identify the product and its purchase price. The bar code may additionally be used for inventory purposes.

It is, therefore, desirable to provide a consumer-centric approach to RFID point of sale transactions.

### SUMMARY OF THE INVENTION

It is an object of the present invention to obviate or mitigate at least one disadvantage of previous RFID point of sale transaction systems and methods.

According to an embodiment, the present invention provides a consumer-centric point of sale transaction system comprising a wireless appliance, a hard copy product and a Mobile Point-of-Sale (MPOS) system within a wireless telecom network. The term MPOS represents the Mobile Point-of-Sale transaction system within a wireless telecommunications infrastructure. The wireless appliance includes a radio frequency identification (RFID) reader and a wireless appliance RFID tag. The hard copy product includes a product RFID tag. The MPOS transaction system is to provide product information and purchase options to the wireless appliance based on the product RFID tag, and to perform point of sale transactions.

In another aspect, there is provided a consumer-centric point-of-sale (POS) system comprising a wireless appliance having a radio frequency identification (RFID) reader/writer transceiver; at least one product RFID tag; at least one financial institution; wherein when the RFID reader/transceiver senses the at least one product RFID tag, the user is prompted with the opportunity to purchase a product associated with the RFID tag; whereby if the users wishes to purchase the product, the wireless appliance validates authorized payments and communicates with the financial institution to complete a transaction.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a consumer-centric point of sale transaction system according to an embodiment of the present invention;

FIG. 2 is a consumer-centric point of sale transaction system according to another embodiment of the present invention;

FIG. 3 is a consumer-centric point of sale transaction system according to a further embodiment of the present invention;

FIG. 4 is a consumer-centric point of sale transaction system according to yet another embodiment of the present invention;

FIG. 5 is a consumer-centric point of sale transaction system according to an embodiment of the present invention;

FIG. 6 is a consumer-centric point of sale transaction system according to a further embodiment of the present invention; and

FIG. 7 is a flowchart of a method of performing a consumer-centric point of sale transaction.

### DETAILED DESCRIPTION

Generally, the present invention provides a consumer-centric point of sale transaction system and method using radio frequency identification (RFID) technology.

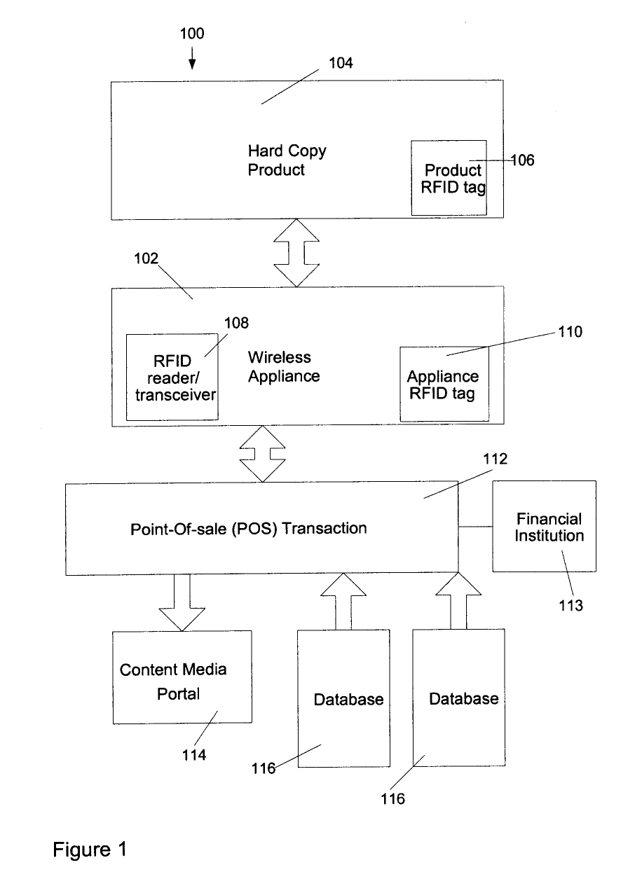

FIG. 1 is a block diagram of a consumer-centric point of sale transaction system according to an embodiment of the present invention. The system 100 includes a wireless appliance 102 which transmits and receives signals from a product or advertising material 104, such as in a magazine, news paper insert, brochure, posted signage or a catalogue. The signals received typically represent menu information relating to the product or a transaction, such as for purchase of the product. The term “wireless appliance” is preferably a mobile device, such as a hybrid cell phone with WiFi or WiMax functionality, home or office cordless remote phone, television remote, or any device or appliance capable of connecting to a wireless telecommunications infrastructure or Internet Service Provider (ISP) used as a Point-Of-Sale Portal directly by a user.

The product 104 includes a product RFID tag 106 and the wireless appliance 102 includes an RFID reader/transceiver 108 and an appliance RFID tag 110. The appliance RFID tag 110 is used to identify the wireless appliance 102. Although an RFID reader/transceiver 108 and tags 106 and 110 are described in this embodiment, other near field communication chips, devices or modules are contemplated. Any other contactless communication or contactless payment systems can alternatively be used.

The wireless appliance 102 is in communication with a Point-of-Sale (POS) transaction network 112, such as a TELCO POS transaction network or a mobile POS network, over which transactions can be processed, preferably via a SMS text messaging network. A financial institution 113 is connected to the transaction network 112 for providing the necessary finances to complete a transaction. Communication between the wireless appliance 102 and the POS transaction network 112 is via the RFID reader/transceiver 108 which enables the transaction. The RFID reader/transceiver 108 initiates a link to the POS transaction network 112, which is then responsible for executing the transaction. This process will be described in more detail below. The POS transaction network 112 is used to enable POS transactions, thereby reducing interoperability problems which may be introduced by different vendors implementing different systems.

The secure POS transaction network 112 is also in communication with a content media portal 114. If the product the user is purchasing is digital media content, after the financial portion of the transaction has been completed, the purchased digital media content is retrieved from a database 116 (within a set of databases) and then forwarded to the content media portal 114. Alternatively, the purchased digital media content may be delivered directly to the wireless appliance 102. Additionally, the user can receive emails confirming sales and providing shipping details or receipts and product-return policy information. The purchased digital media content is identified by the product RFID tag 106 in the hard copy product 102.

The digital medial content is preferably transmitted via a transmission medium or scheme, such as a cable, DSL, Satellite, WiFi, WiMax, BPL, UltaWide Broadband, UMTS/HSPDA, or Broadband wireless. The wireless appliance 102 is connected locally to the content media portal 114 via Bluetooth, WiFi, WiMax or UltraWide Broadband, “which is the 2^{nd} generation of Bluetooth”.

The content media portal 114, or third party service stores whatever content or menu items have been ordered by the consumer. The content can then be redirected to another connected appliance, such as a home computer or subscription service. This is advantageous if a consumer obtains information regarding a product while browsing in a store, and wants to review the information at a later time. This can also enable the provision of information to a wireless appliance, which can then be redirected to another device more suitable for the viewing of such information, such as media-rich content (e.g. a detailed video of a product or service). At least one repository, or database, 116 stores the digital media content. The digital media content may be provided by an advertiser, a retailer, a Telco, a manufacturer, or any other entity. This system 100 can be used by an advertiser to provide information or discounts, a retailer to add their mark-up, and the POS network to enable the transaction. Advertisers may provide an advantage over paper-based rebates or discounts since the consumer knows that the discount will be immediately applied which may result in increased sales. Such a system according to an embodiment of the present invention can also promote impulse buying, both in terms of providing information and discounts relating to products for sale.

The consumer executes transactions to purchase goods and services. Transactions involving multimedia content are described in relation to the concept of content range authentication are described in PCT Application CA 2006/000194 which is herein incorporated by reference.

In one mode of operation, in an automatic “read mode”, the wireless appliance, or phone, receives a menu item providing simple access to pushed content as a direct result of reading the RFID Tag. The menu item on the phone can provide links to additional advertisements associated with the newly pushed menu providing related content information such as “best price list options” and the option to purchase the item or product as well. Information can be provided even before someone has bought a magazine, such as when they are browsing in a store. This can provide valuable marketing data and revenue streams that are not presently available by any other means. The menu contents are provided via the POS transaction network, and the content itself can be created and/or formatted by a menu provider, such as an advertisement agency or third party provider supporting a host of advertisement agencies pushing content to the transaction network, for eventual use on subscriber handsets.

The system is a centrally controlled system in that the technology to perform a transaction is centrally controlled, and is not controlled in the wireless appliance.

As described above, the hard copy product, or material 104 typically includes the RFID tag 106. This provides a direct hard copy marketing link to any radio frequency reader by any small business, consultant or other requirement necessitating additional or confidential information scanned by the RFID reader/transceiver 108 for additional downloading of data.

Although many methods of embedding the RFID tag 106 on magazine pages 104 is known, the RFID tag 106 is preferably embedded using a print-based implementation. In this method, an ink jet printer is fitted with two additional cartridges; one containing an epoxy based conductive ink and the other containing passive RFID chips (which serve as the RFID tags). The antenna can also be pre-installed to the RFID chop and affixed to a substrate or directly onto paper as well. Using a software interface such as Microsoft Office™, for example, the RFID tag may be embedded with a embedded string or number within a Word™ document, a highlighted letter, a logo or any other graphic.

Firstly, the user highlights, using the software interface, the desired letter, or graphic where the user wishes to embed the RFID tag, much in the same manner any word or phrase is highlighted. In the case of a conductive ink application to the RFID chip, the highlighted letter or graphic is then traced with a series of dots connected by lines in the form of a vector indicating where an RFID antenna, associated with the RFID tag or chip, is to be located. After the tracing, the RFID tag is placed at either end of the vector, depending on user preference. In the case of a pre-installed antenna on the RFID chip, both the chip and the antenna are placed onto the region of interest on the document and then printed over. After the RFID tag has been placed, the user embeds an encrypted string, number or non-encrypted IP based link on the traced vector within the RFID tag. After the string, number, no-encrypted IP is embedded, the user then prints the document using the ink jet printer, whereby the ink jet, when encountering the dots/vector in the letter or graphic applies the conductive epoxy based ink, and then the RFID tag is affixed with the epoxy at either end of the vector. After the application of the RFID tag, an RF reader/writer within the ink jet printer writes the desired string, number or IP based link to the RFID tag, and then test-reads the embedded data before printing the remainder of the document.

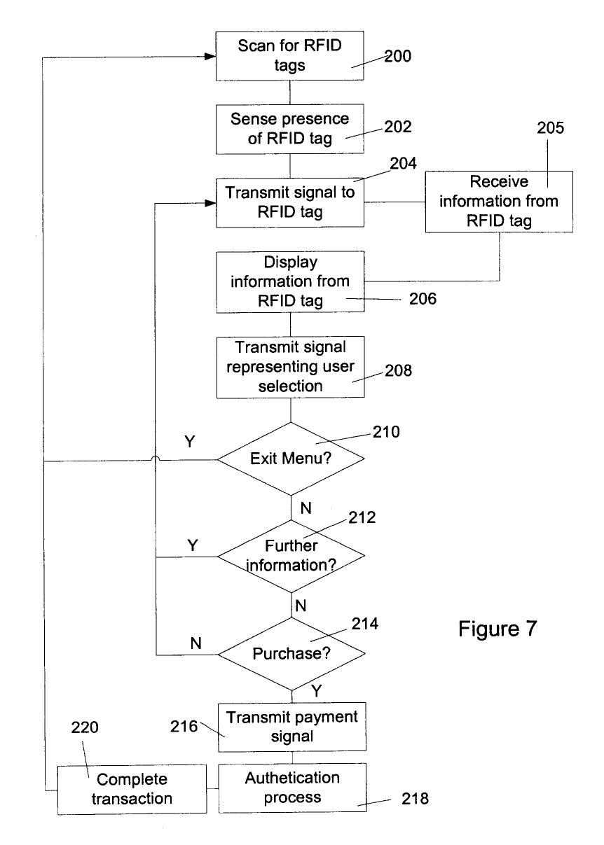

Turning to FIG. 7, a first embodiment of a method of performing a consumer-centric RFID POS transaction is shown. It is assumed that a user is in the possession of a wireless appliance having an RFID reader/transceiver and a wireless appliance RFID tag. In operation, when the system is in the automatic scan mode, the RFID reader/transceiver in the wireless appliance is constantly transmitting scanning signals to determine the presence of product RFID tags (step 200). Once the reader/transceiver is able to sense the presence of a product RFID tag (step 202), the wireless appliance transmits a signal/message (step 204), preferably in the form of a call, such as via an SMS text messaging network, to the product RFID tag to retrieve and receive information stored on the product RFID tag (step 205). Alternatively, the RFID tag may be set to sense the presence of a wireless appliance (or RFID reader associated with the wireless appliance) and then push the information to the wireless appliance.

The information provided by the product RFID tag preferably relates to information identifying the product and a menu allowing the user to select from various options such as, but not restricted to, purchasing the product, exiting from the menu or requesting further information relating to the product.

The information is then displayed on the wireless appliance to the user (step 206) and then after the user selects an option, a signal associated with the selected option is transmitted accordingly (step 208). For instance, if the user selects to exit from reviewing the information (step 210), the wireless appliance cancels the call and the wireless appliance returns to scanning for RFID tags (step 200).

Alternatively, if the user requests further information from the product RFID tag (step 212), the wireless appliance transmits another signal to the product RFID tag requesting this information (step 204) which is then displayed on the wireless appliance (step 206). Although not shown, the user may also have the option to access the Internet via a link embedded in the information provided by the product RFID tag.

Otherwise, if the user decides to purchase the product (step 214), the wireless appliance is used to transmit a signal to a financial institution to authorize payment for the product (step 216). It will be understood that the wireless appliance must be previously registered with a financial institution such that all banking information is previously stored in a database and associated directly with a subscriber's account.

After the authorized payment signal is transmitted (step 216), the wireless appliance proceeds to an authentication process (step 218). It will be understood that, for security reasons, the wireless appliance must be authenticated so that the transaction is deemed valid such that it is being requested by the registered owner of the appliance or an individual with access to the authentication information.

Many authentication processes are possible and well known in the art. One such process is with a simple password entry. Another such process may include the use of a SMART card which is issued directly by the financial institution representing the account holder's subscription and contains personal identification information relating to the wireless appliance owner. Signals are transmitted from the wireless appliance and SMART card to the financial institution via the transaction network to authenticate the user. In this manner, the authentication may only occur if both the SMART card and the wireless appliance are in close proximity with each other. Therefore, if either the SMART card or wireless appliance is stolen, no purchases are possible. After the user is authenticated, the transaction is completed (step 220). As can be seen from the method, there is no need for the user to take the product to a register and wait in line to purchase the product.

It will be understood that if the product being purchased is digital media content, after the transaction is completed (step 220), the purchased digital media content is transmitted from the database 116 to the requested destination, such as the wireless appliance 104 or the content media portal 114.

If in the event that a transaction is interrupted for any reason, such as service over the wireless network being interrupted, the mobile appliance is disabled, marketing or product archives are “in-process” of updating relevant data, financial institution networks are down, a bank or retail ATM is disabled or out of money, a personal theft of the mobile device or authorization card during, or immediately after a transaction of any kind has been initiated, or an accident during, or immediately after a transaction of any kind has been initiated, the system includes an independent compartmented holding repository to temporarily store aborted transactions, digital content deliverables or scanned product information until the transaction can be resumed.

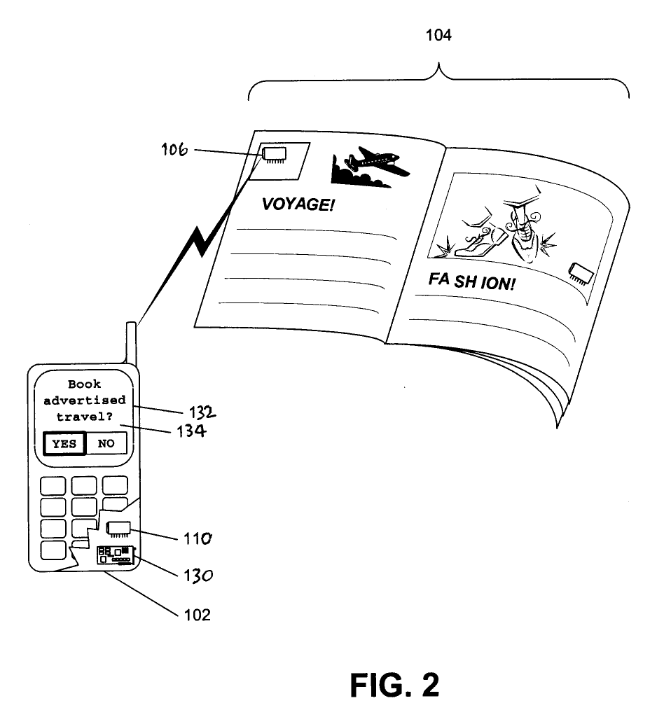

FIG. 2 is a consumer-centric point of sale transaction system according to another embodiment of the present invention. The wireless appliance 102 is shown in communication with a hard copy product 104.

Aside from embedding an RFID reader/writer 130 directly into the wireless appliance 102, the wireless appliance 102 may comprise an external RFID reader/writer in another electronic device which communicates with the wireless appliance 102. If the RFID reader/writer is external, communication between the wireless appliance 102 and the other electronic device is preferably via Bluetooth technology.

If the system includes an external RFID reader/writer, the wireless appliance 102 may then serve as a proxy to the reader/writer device. As described above, the reader/writer or reader/transceiver device is used to scan, communicate with, the RFID tag 106 in the hard copy product 104. After being scanned and contacted, the product RFID tag 106 transmits information, in the form of signals to the wireless appliance 102. On a wireless appliance display 132, a menu item 134 of information and/or purchase options is provided based on the information transmitted from the product RFID tag 106. The menu structure and associated information that is pushed to the wireless appliance is from a menu provider (e.g. advertiser or third party vendor).

Based on the infrastructure provided about the POS system, the RFID tag 106 may be glued, stuck or attached by any number of methods, such as how perfume inserts are provided in magazines. Another possible method of placing the RFID tag 106 in the hard copy product 104 is via the print based implementation discussed above.

In this embodiment, book stores and publishers are provided with another method of advertising to their consumers who do more browsing than purchasing at magazine racks by virtue of the proximity of the RFID tag 106 to the wireless appliance 102. The wireless appliance scans the RFID tag 106, or vice-versa, and then the user may automatically retrieve the information from the RFID tag 106 and bookmark the information for later access without purchasing the hard copy material 104.

If consumers purchase the hard copy product, the hard copy product may include more than one RFID tag throughout the magazine that could be scanned.

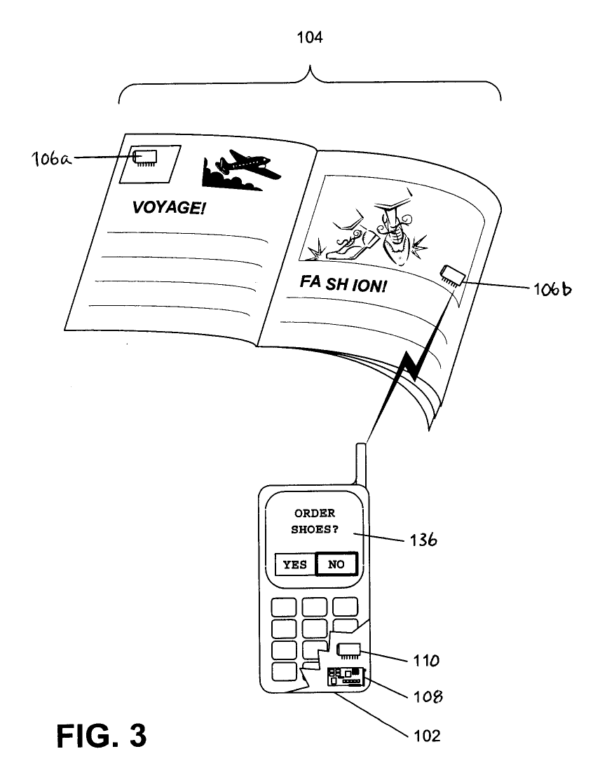

FIG. 3 is a consumer-centric point of sale transaction system according to a further embodiment of the present invention. In this embodiment, the hard copy product 102 includes a plurality of product RFID tags 106. One of the RFID tags 106a offers information based on a first advertised product, such as a vacation while a second RFID tag 106b provides information related to a different advertised product in the same hard copy product 104. As with the previous embodiments, the wireless appliance 102 scans the hard copy product 102 for RFID tags 106 and then requests information relating to these products from the associated RFID tags, or vice versa where the RFID tag senses the reader/writer and pushes the information to the wireless appliance, which is then displayed in a menu 136.

The scanning range of an RFID tag is limited by the length of the antenna attached to the tag 106. The longer the antenna, the further the distance between the wireless appliance and RFID tag 106 required for scanning. Distance may be important, as it distinguishes many applications.

In the case of magazines or books, the distance required between the RFID tag and the wireless appliance 102 for communication is preferably extremely short so that the consumer is required to have the wireless appliance within centimeters of the RFID tags to receive information. A plurality of RFID tags may be located in various portions of a page as there may be several tags located on the same page. For example, a certain length can be defined for “smart shelves” in retail outlets allowing consumers to scan and acquire lists of product information and pricing by traversing through the aisles.

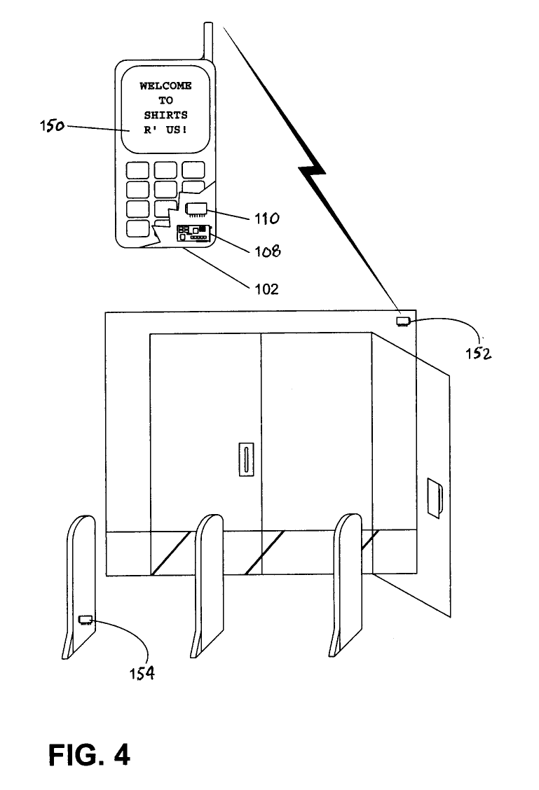

In the case involving the consumer, the wireless appliance 102 also serves as a Point-of-Sale device as schematically shown in FIG. 4. By merely walking through the entrance way, the consumer's hand-held device, or wireless appliance 102, may display the retail store's logo or message as part of a menu 150. This can be triggered by an entrance way RFID tag 152 or an entry/exit gate RFID tag 154. Since the wireless appliance is continuously scanning for RFID tags, or vice versa, the wireless appliance senses the presence of the entrance way RFID tag 152 and/or the entry/exit gate RFID tag 154 as the user is entering or exiting the store. The information retrieved from either or both of the RFID tags may inform the user that the wireless appliance may be used as a Point-of-Sale apparatus allowing the consumer to automatically identify and purchase a product without having to line up at a counter. A transaction area is preferably provided at an entry/exit area in the store, through which a user must travel in order to enable POS capability on the wireless appliance. An MPOS mode activation indication, such as a green light or other indicator, can be provided to, or via, the wireless appliance to indicate to the user that they are in a transaction zone. A purchase indication, such as a red light or other indicator, can be provided to, or via, the wireless appliance to indicate purchase complete.

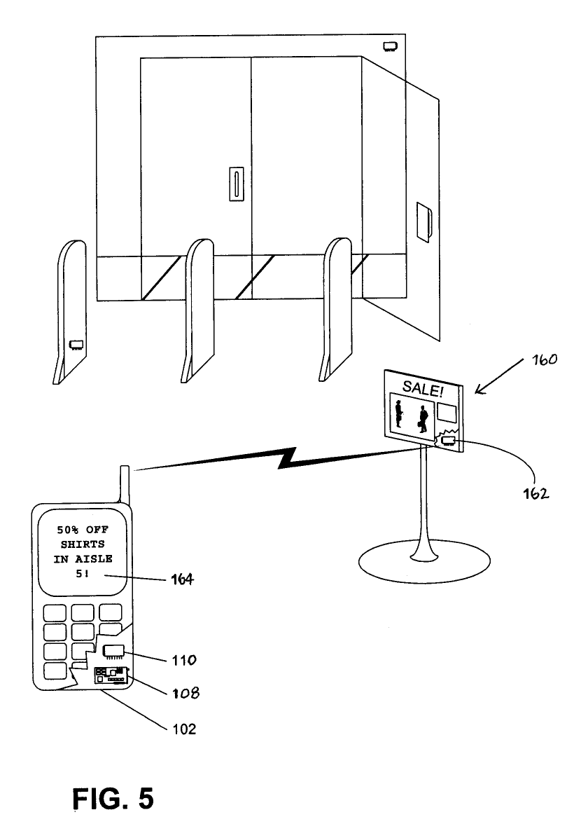

As shown in FIG. 5, a consumer-centric RFID system according to yet another embodiment of the invention is shown. In this embodiment, the system is used to convey information relating to product locations within the store, and/or provide lists of specials or sales. An in-store advertisement sign 160 having a sign-based RFID tag 162 is preferably located within the store. As the user passes by the sign 160, the wireless appliance 102 senses the presence of the RFID tag 162 and communicates with the tag 162 , via a RFID reader/transceiver 108 to receive information associated with the sign 160. This information is then displayed on the wireless appliance, preferably in the form of a menu 164. As will be understood, the information provided many simply be an informational message rather than a menu. Alternatively, the menu may display prices for products as the consumer passes each product, allowing a user to select whether or not the product is selected for purchase automatically or manually, allow the consumer to return previously purchased products, and/or pre-order items currently out of stock.

Alternatively, RFID transceivers and tags may be used to trigger functions and features on the consumer's handheld, or wireless, device. When the consumer passes through the entrance way of a retail store, panels or sensors (including embedded RFID tranceivers) on either side of the entrance way detect an appliance RFID tag embedded within the phone. If the user's wireless appliance is defaulted to trigger a POS mode through an RFID transceiver within the wireless appliance, this automatically triggers a signal to the store's wireless network to place a communications link to the wireless device, such as a hybrid cell phone allowing the wireless appliance to communicate with RFID tags and transceivers in the store. The user's mobile device display receives a logo indicating that the MPOS is active and initiated for a particular retailer.

The MPOS transaction comprises the transmission of an authorized payment sent via the wireless telecommunications network, which then sends that payment confirmation directly to the retail clerk's display at the counter acknowledging payment received for purchased goods or services. The proximity of the subscriber's mobile device to the cashier's display terminal provides nothing more than an IP address scanned from an RFID tag embedded anywhere near the checkout area informing the POS transaction system where to send payment confirmation information. The RFID tag is fully encrypted and unique only to the IP address associated with the cashier's display terminal. Specific information transmitted to the cashier's display may include: consumer name; consumer bank card accounts or credit cards previously approved and entered and registered by the consumer for POS transactions; consumer's Photo ID and digitized signature stored within the hand held device. A consumer can also select “Payment in Cash”, or “traditional bank card or credit card payments without the use of the MPOS device”. A consumer's PIN number plus the mobile devices unique ESN, text based password, or voice password can by encrypted within the authorization smart card , or discrete utterance voice recognition tokens can be included as part of a Bio-ID integration additionally used for executing transactions.

The consumer may speak a voice command or press a button to manually to select the item for purchase from the mobile device as products are accumulated during the shopping experience. If the consumer has a cart, the cart can contain an RFID transceiver and scan, trigger, and select the item on the consumer's list automatically via Bluetooth within the cart's transceiver paired with the subscriber's mobile device.

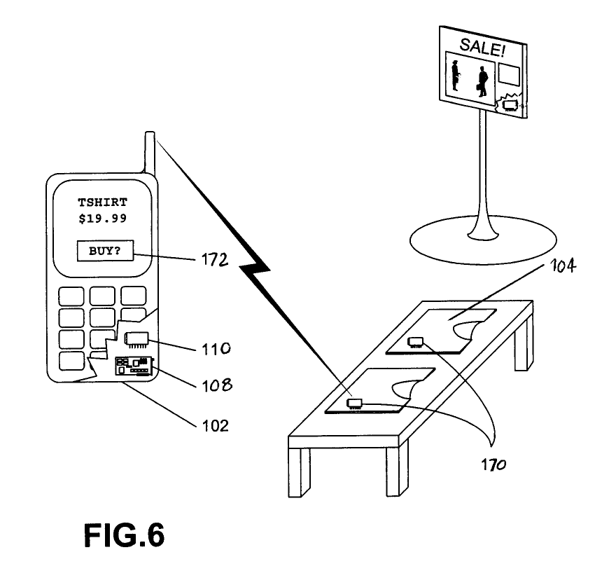

RFID transceivers and tags may be used within the retail space to trigger functions on behalf of the retail business from the hand held device in concert with the retail store's purchasing system, locally and regionally, and nationally. For example, FIG. 6 illustrates the facilitation of an on-site purchase of a product, such as a t-shirt, having its own product RFID tag 170 via a specialized menu 172 on the wireless appliance 102. As before, the information displayed in the menu may either be retrieved from the product RFID tag by the wireless appliance or pushed to the wireless appliance by the RFID tag. After the information from the product RFID tag has been displayed on the wireless appliance, the user has the option to purchase the product.

Upon exiting through a portion of the retail store, the consumer can formally bag and manually check-out or automatically check-out the product. Methods can vary by executing a menu feature, along with stored voice commands, PIN numbers and Photo ID's with digitized signatures or automatically and transparently consummate a purchase transaction via the authorization smart card associated with the mobile device. The user/consumer may alternatively have the flexibility in the Check-Out mode to manually pay by cash, or manually pay by bank or credit card payments. In an MPOS manual mode, the user/consumer selects the pre-registered method of payment then awaits a green light, or other confirmation/acknowledgement, to exit the retail store's spaces. In POS automatic mode, the consumer merely walks through the front of the store and awaits a green light to exit the retail store's spaces.

In the POS manual mode, the user is required to manually be authenticated by the POS transaction network before the transaction is completed. In the POS automatic mode, the authentication process is performed automatically and therefore the user simply has to wait for confirmation after sending the initial purchase request. As discussed previously, the financial portion of the transaction may be automated through the authentication process between the wireless appliance, authorization smart card containing the RFID tag with the encrypted bank account PIN and mobile device's unique ESN and the financial institution.

In either manual or automatic mode, the consumer's ID PIN number is preferably sent via the wireless device's authentication smart card, in the case of manual payments requiring signatures, and compared to the information stored at the financial institution. The Photo-ID can be displayed on or at the Retail Store's automatic check-out center to review as the check-out occurs. The user's wireless appliance can automatically send the confirmation via the wireless telecommunications network, who will then transmit it in real-time to the retail store. All transactions are then consummated by the POS transaction network to the financial institution and reported in real-time.

With the consumer-centric POS transaction system according to an embodiment of the present invention, the consumer is comforted with the knowledge that there is less or no likelihood that a local store employee or person within the retail store can affect the POS transaction as the POS network 112 is entirely independent of the retailer. The retailer merely receives confirmation that their account has been deposited.

In another embodiment of the financial portion of the transaction, an encrypted interface is used between the wireless appliance and authorization (SMART) card and an ATM Machine. The authorization card is used as proxy on behalf of the bank account holder instead of physically entering a PIN itself. The authorization card has an RFID tag embedded in it including at least two parts: a personal identification number (PIN) and a wireless appliance, or cell phone, ESN. The ESN is a unique identifier to every cell phone, recognized by cell towers as an authorized paying cell phone subscriber. The authorization card, held within the subscriber's wallet or purse is read by an RF reader in the ATM reader prior to a transaction. Both the subscriber's PIN and cell phone ESN is combined and encrypted. The combined encoded number is read directly by the ATM's RF reader. In this case the ATM's RF reader is making the assumption that the account holder is carrying their cell phone as well as the authorization card. The ATM will, in effect obtain 2 separate and independent validations from the account holder. The first validation is the authorization card itself and the second is the validation from the account holder's cell phone, as the cell phone passes the encoded number to the ATM as well. The cell phone does not hold the encoded combination PIN+ESN, but the cell phone is unique to the authorization card passing the encoded PIN+ESN. If the bank account holder/subscriber loses both their wallet and cell phone, it would be more than likely to be noticed by the account holder/subscriber immediately, rather than merely losing the cell phone or authorization card/wallet independently of each other.

The ATM RF reader is preferably about 1 inch square and as thin as a few sheets of paper contained within a sticky piece of plastic. The RF reader within the ATM has a connector ribbon whereby the encoded PIN+ESN is passed physically to the ATM's PIN interface.

The bank account holder can go on using the ATM's display interface as traditionally used today. In one method, the account holder may register with a financial institution through the following steps. Firstly, the bank account holder registers for the RFID subscription and credit protection plan by providing information concerning bank cards or credit cards associated with an account. Secondly, when approved, the Bank then provides an Authorization RFID enabled smart card to the account holder. Upon approval, the bank account holder is authorized to go to any retail outlet, telecom provider or consumer electronics kiosk to pick up any of the available RFID enabled eCommerce cell phones. Upon receiving the phone from the retailer, the phone is then activated on behalf of the new subscriber. The new subscriber then uses the newly acquired cell phone to activate their RFID enabled Authorization Smart Card by calling the number provided by the bank much in the way debit or credit cards are currently activated. During the phone call to activate the authorization card, the cell phone's embedded RFID Reader/Writer preferably receives the bank account holder/subscriber's encoded PIN, which is then combined to the cell phone's internal ESN number as the new encrypted authorization code used to trigger scan events, ATM or retail transactions. The newly combined PIN+ESN is then written once to the authorization card's embedded Passive RFID tag by the RF Writer in the mobile device. This action only occurs once and cannot be duplicated deleted, or modified after the write occurs. Since both the mobile device and the authorization card are now synced, this enables the new subscriber to begin scanning RFID enabled hard copy material, or complete ATM or retail purchase transactions.

In a further embodiment, the wireless appliance may serve as a shopping cart, hand-held basket, or any other item carrying device. The RFID reader can be embedded within an upper edging of a shopping cart; in a manner that is transparent to the consumer (i.e. the consumer cannot tell visually whether the shopping cart includes an RFID reader). The embedded, or otherwise provided, RFID reader can automatically detect items that are placed in the item carrying device, can prepare the items for purchase, and can preferably perform the transaction, possibly in conjunction with a wireless appliance identifying the consumer.

The invention also provides a novel method for companies to market to consumers. By embedding marketing information in RFID tags, any wireless appliance close to the RFID tag receives information from that tag thereby allowing the product to be pushed, or marketed to another user. This can provide valuable marketing data that is not presently available by any other means.

In another embodiment, rather than having the wireless appliance continuously scanning for RFID tags, external readers may be used to sense the presence of appliance RFID tags and automatically transmit associated information, such as product information, to the wireless appliance.

Alternatively, once a transaction is completed, the RFID tag may be programmed to blow the fuse on the RFID tag/chip in order to allow the system to be for one time use or the fuse may be blown once the RFID tag is programmed so that no viruses may be programmed to the tag. The RFID tag in the authorization card may also be programmed in this manner.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A consumer-centric point-of-sale (POS) system comprising:
a wireless appliance having a radio frequency identification (RFID) reader/writer transceiver;
at least one product RFID tag;
at least one financial institution;
wherein when said RFID reader/transceiver senses said at least one product RFID tag, said user is prompted with the opportunity to purchase a product associated with said RFID tag;
whereby if said users wishes to purchase said product, said wireless appliance validates authorized payments and communicates with said financial institution to complete a transaction.

2. The consumer-centric POS system of claim 1 wherein said at least one product RFID tag is embedded in a product, a hard copy product, a sign or a store entrance/exit.

3. The consumer-centric POS system of claim 2 wherein said hard copy product is a magazine or a book.

4. The consumer-centric POS system of claim 3 wherein said product RFID tag is printed on a page of said hard copy product.

5. The consumer-centric POS system of claim 1 further comprising:
a SMART card system, associated with said wireless appliance, providing authentication identification information to said financial institution.

6. The consumer centric POS system of claim 1 further comprising a point-of-sale transaction network for connecting said wireless appliance to said financial institution.

7. The consumer-centric POS system of claim 1 further comprising a set of databases for storing digital content wherein said digital content is said product.

8. The consumer-centric POS system of claim 7 further comprising:
a content media portal for receiving said digital content after said transaction is completed.

9. The consumer-centric POS system of claim 7 wherein said wireless appliance includes means for receiving purchased digital content from said set of databases.

10. A method of performing consumer-centric business transactions comprising the steps of:
sensing presence of a product radio frequency identification (RFID) tag;
communicating with said product RFID tag to receive information relating to a product associated with said RFID tag;
displaying said information as a plurality of menu selections to a user.

11. The method of claim 10 further comprising the steps of:
receiving a user selection of one of said plurality of menu selections;
wherein if said user selection is to purchase said product, said method further including the steps of:
transmitting a signal to a financial institution;
authorizing said purchase; and
completing said purchase.

12. The method of claim 10 further comprising the steps of:
receiving a user selection of one of said plurality of menu selections;
wherein if said user selection is to review more information, said method further including the steps of:
transmitting a second signal to said product RFID tag;
receiving further information from said RFID tag; and
displaying said further information to said user.

13. A consumer-centric POS system comprising:
a plurality of product radio frequency identification (RFID) tags associated with a plurality of products;
a wireless appliance including an RFID reader/writer transceiver for communicating with said plurality of product RFID tags;
wherein when said RFID reader/transceiver senses a presence of one of said plurality of product RFID tags, said product RFID tags provide information relating to said associated product to said wireless appliance.

14. The consumer-centric POS system of claim 13 wherein at least one of said product RFID tags is embedded in a hard copy product.

15. The consumer-centric POS system of claim 14 wherein said hard copy product is a magazine or a book.

16. The consumer-centric POS system of claim 15 wherein said at least one product RFID tag is printed on a page of said hard copy product.

17. The consumer-centric POS system of claim 1 further comprising at least one authorization card containing an RFID tag or other similar device providing two forms of validation in the case of a purchase transaction.

18. The consumer-centric POS system of claim 1 further comprising a repository or archive to temporarily park a transaction in the event of a purchase transaction interruption.

19. A method of performing consumer-centric business transactions comprising the steps of:
sensing presence of a wireless appliance;
pushing information associated with a product to said wireless appliance for display to a user;
performing a transaction with respect to said product.
